(19) United States
(12) Patent Application Publication
(10) Pub. No.: US 2005/0225269 A1
(43) Pub. Date: Oct. 13, 2005

(54) Tubular motor

(76) Inventor: Michael Barak, Haifa (IL)

Correspondence Address: DENNISON, SCHULTZ, DOUGHERTY & MACDONALD, 1727 KING STREET, SUITE 105, ALEXANDRIA, VA, 22314, US

(21) Appl. No.: 10/432,623

(22) PCT Filed: Dec. 11, 2001
(86) PCT No.: PCT/IL01/01145

§ 371 Date: Dec. 15, 2003

(30) Foreign Application Priority Data
Dec. 11, 2000 (IL) 140209

(51) Int. Cl. H02P 1/54

(52) U.S. Cl. 318/56

(57) ABSTRACT

A tubular motor including a driving systen and a winch mechanism enclosed within a common tubular housing, the driving system including a DC motor and a unitary power supply, the unitary power supply being electrically connectable to an AC electricity source external to the housing and to the DC motor within the housing, and being adapted to convert AC electricity supplied by the AC electricity source into low voltage direct current electricity suitable for the DC motor, by transformation and rectification. The winch mechanism is coupled to and driven by the DC motor.

### FIELD OF THE INVENTION

The present invention relates to tubular motors in general, and, in particular, to tubular motors serving as driving systems for opening and closing vertically hanging planar structures, such as Venetian blinds, roller blinds, sash windows and the like.

### BACKGROUND OF THE INVE NTION

The tubular motor is a well-known means for the automated opening and closing of Venetian blinds, roller blinds and similar vertically hanging screens. Tubular motors for these purposes are typically required to provide torques of about 5-50 Nm, and are generally powered by the mains electricity, as supplied by the distribution network. They consist of a tubular housing, usually a metal tube having a circular or a polygonal cross-section, which is insertable into the spindle (roller) of a roller blind, the headrail of a Venetian blind, or some similar, unobtrusive location. The tube-contains both the driving system and the winch mechanism for folding, winding or otherwise displacing the hanging screen to which they are coupled.

Tubular motors of the crowded prior art use either compact DC motors or asynchronic AC motors as the central element of their driving systems. When a tubular motor containing a DC motor is used, before it can be powered by an AC power supply, such as the mains, the supply current has to be rectified and transformed. Available transformers and rectifiers are too large to fit into the spindle or headrail of a blind, and a bulky, external power pack comprising these components is required, between the mains socket and the tube. Suitable power packs may be directly plugged into a mains outlet socket, but they are heavy, and have a tendency to pull the sockets out of the wall, or to damage their own pins. Alternatively, they may be wall-mounted under the spindle or headrail. Due to their bulk, these power packs are unaesthetic and generally awkward and inconvenient. On the other hand, AC motors, such as the common asynchronous cage-rotor type motors, do not require bully rectifiers and transformers. However, to fit an AC motor of this type into a motors, do not require bulky rectifiers and transformers. However, to fit an AC motor of this type into a narrow tube, costly monofilament wires are required for its coils. Apart from being relatively expensive, small AC motors of this type have only very low efficiency rates, of around 4-6%, and warm up rapidly in use. To protect the coils of fine wire from overheating and burning up, a thermostat, or other protective device, is used to cut the current supply after only about 4 minutes of operation. Additionally, mains driven AC motors are powered by relatively high voltage electricity: 120 V in the United States and 240 V in the UK and elsewhere. To enable the dispersion of heat, the housing for such motors is generally required to be heat conductive, and in consequence, is electrically conductive. The proper earthing of such devices is critical.

Accordingly, there is a long felt need for a narrow tubular motor, suitable for mounting within, the spindle or headrail of a blind, that can be connected straight to the mains electricity supply without requiring intermediate transforming/rectifying components mounted externally to the tubular motor housing. Preferably, such a tubular motor would have a relatively high efficiency rate, a low weight, and a simple construction, and would generally include, in addition to the driving system, a winch mechanism located within the housing.

### SUMMARY OF THE INVENTION

The present invention provides a tubular motor comprising a driving system and a winch mechanism enclosed within a common tubular housing, where the driving system includes a DC motor and a unitary power supply situated within the housing, and being electrically connectable to an AC electricity source external to the housing, such as the mains, and to the DC motor within the housing, and being adapted to convert AC electricity supplied by the AC electricity source into low voltage direct current electricity suitable for the DC motor, by transformation and rectification. The winch mechanism is coupled to and driven by the DC motor of the driving system.

The tubular motor may be coupled to a vertical partition suspended from a horizontal bar, and enables the automated displacement of the vertical partition.

Examples of such vertical partitions include Venetian blinds, curtains, roller blinds, fly screens, mosquito nets, sash windows, projection screens, chalk boards, marker boards and the like.

The horizontal bar may itself constitute the aforementioned tubular housing.

Preferably, the driving system further includes a drive unit that includes a logic circuit for controlling operation and braking of the DC motor. The logic circuit preferably is enabled to sense a current increase when the motor has reached an end course.

The DC motor is preferably a collector type motor, including a solid magnet stator, and a wire coiled collector rotor, having three or more electromagnetic poles.

The winch mechanism preferably includes a planetary reduction gear, such as a three-stage gear, for example.

Preferably, the tubular housing is electrically insulating, and is less than 1½ inches wide, and may be as little as 1 inch wide.

Preferably the tubular motor includes a battery for providing direct current, serving as a back up in the event of failure of the AC power source.

### BRIEF DESCRIPTION OF THE DRAWINGS

The present invention will be further understood and appreciated from the following detailed description taken in conjunction with the drawings in which:

FIG. 1 is a schematic block diagram showing the main components of a generalized embodiment the tubular motor of the present invention.

FIG. 2 is a sectional view of a tubular motor constructed and operative in accordance with one embodiment of the present invention.

FIG. 3 is a schematic illustration of a tubular motor according to the invention mounted in the headrail of a Venetian blind.

FIG. 4 is a schematic illustration of a tubular motor according to the invention mounted in the spindle of a roller blind.

FIG. 5 is a circuit diagram of an exemplary drive unit.

FIG. 6 is a circuit diagram of an exemplary power supply unit.

FIG. 7 is an engineer's plan of the DC motor of a working prototype tubular motor.

FIG. 8 is a graphical representation summarising the characteristics provided by the working prototype tubular motor.

### DETAILED DESCRIPTION OF THE INVENTION

The present invention relates to a tubular motor including a driving system, and a winch mechanism housed within a tubular housing. The driving system includes a DC motor and a unitary power supply mounted together within the tubular housing. The unitary power supply converts AC electricity from an external source, such as the mains, to the DC electricity required by the DC motor, by transforming and rectification. The winch mechanism includes a gear system and a drum, spool or reel, and is coupled to and driven by the DC motor of the driving system. Because of the revolutionary motor design and the use of an oscillatory switching power supply, the diameter of the tubular housing may be as little as 1″, and the tubular motor can thus be mounted within the headrail of a Venetian blind or within the spindle of a roller blind. The tubular motor may be connected to'the AC mains electricity supply via a simple two- or three-wire power cord terminating in a regular electrical plug, without requiring any external transforming or rectifying. This approach overcomes both the external power pack disadvantage of the conventional DC-type tubular motors and the cost and overheating disadvantages of the AC-type tubular motors of the prior art, thus providing a cost-effective, reliable, compact tubular motor.

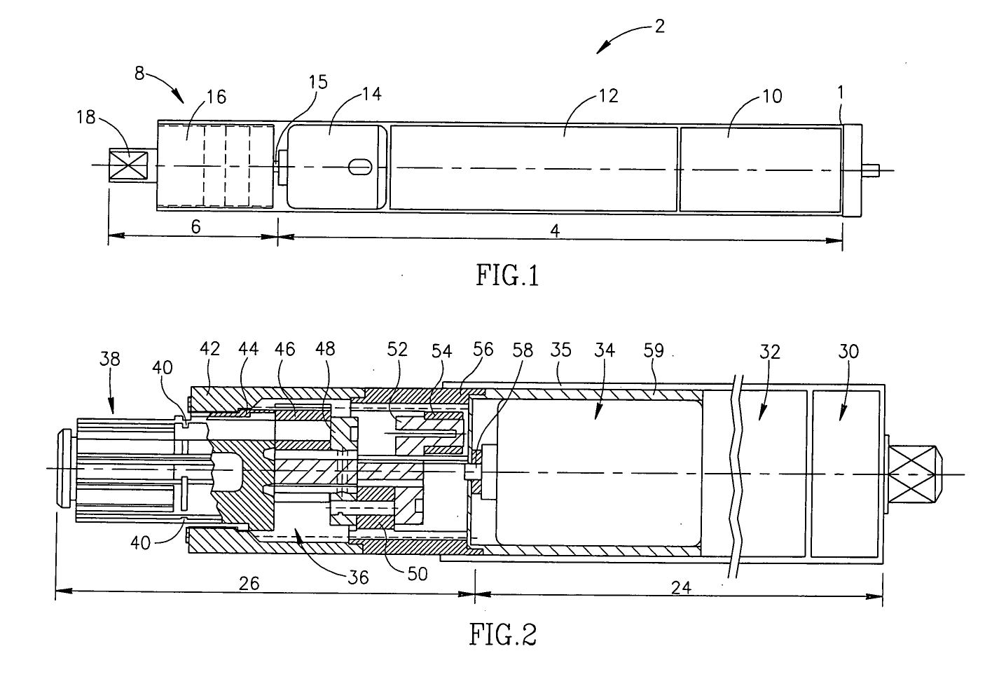

Reference is now made to FIG. 1, which is a schematic cross-sectional block diagram showing the main components of a tubular motor 2 of the present invention, consisting of a drive system 4 and a winch mechanism 6, coupled to and driven by the drive system 4. Drive system 4 and winch mechanism 6 are packaged within a tubular housing 8. The drive system 4 typically includes a drive circuit 10 and a unitary power supply 12 electrically connected to a DC motor 14. The unitary power supply 12 is plugged into an AC electricity source, such as the mains, and converts alternating current as supplied by the mains (110 V in the USA, 220 V in Israel, 240 V in the UK, etc.) to a low voltage direct current, generally 24 Volt, suitable for the DC motor 14, by transformation and rectification.

The rotor of the DC motor 58 is connected to the winch mechanism 6, which typically includes a planetary gear box 16 having 3 or 4 stages, and a drive shaft 18, usually having a polygonal cross-section, such as a hexagonal or square cross-section. By suitably connecting the drive shaft 18 to a vertically hanging screen, the tubular motor 2 enables the automated displacement of the vertically hanging screen. In the case of a roller blind, for example, the tubular motor 2 is mounted within the roller spindle of the blind and the drive shaft directly turns the roller spindle to raise or lower the blind. In a Venetian blind, for example, the tubular motor 2 is mounted within the headrail of the blind, and the drive shaft will rotate a drum onto which the lift cord is wound.

Tubular housing 8 is generally a dedicated housing for the tubular motor, providing a unitary tubular motor that can be attached to or detached from the application to which it is connected. In some embodiments, the headrail of the Venetian blind, or other horizontal bar from which a vertical partition is suspended, is itself the housing of the tubular motor. While conventionally a tubular motor is cylindrical in shape, this is not required. Rather, the tubular housing may be any narrow sleeve of any cross-section into which the components, including the unitary power supply and DC motor, are packed.

Reference is now made to FIG. 2, which shows in sectional view, a tubular motor 20 constructed and operative in accordance with one embodiment of the present invention. Tubular motor 20 includes a driving system 24 and a winch mechanism 26. The driving system 24 comprises a drive unit 30 and a unitary power supply 32 electrically connected to a DC motor 34, to power and control the operation thereof. The unitary power supply 32 transforms and rectifies alternating current as supplied by the mains, to a low voltage direct current, generally 24 Volt, suitable for the DC motor 34. It will be noted, that drive unit 30, unitary power supply 32 and DC motor 34, are seated in a tubular housing 35, preferably formed of plastic. It is a particular feature of the present invention that the motor housing need not be formed from a heat conducting material such as metal, and a light weight plastic housing that provides double insulation may be used. At the end of the tubular housing 35 is a static motor support 37, which may include a square clip to anchor the motor in the desired location.

The winch mechanism 26 essentially consists of a multi-stage planetary gearbox 36 for driving a rotating drive shaft 38. The gearbox 36 is inset into the tubular housing 35, and does not need to be fully enclosed thereby. The gearbox 36 also has locking means 40 thereon, enabling the tubular motor 20 to be physically attached to its location and preventing it from freely spinning, such that the torque produced between the rotor and stator elements is totally applied to the drive shaft.

The inlet of power supply unit 32 is electrically connected to the AC mains power source, (typically, 220 Volt or 110 Volt), and supplies a direct current at its outlet to DC motor 34. The DC motor 34 is preferably of the collector type, consisting of a solid magnet stator, and a wire coiled collector rotor 58, having three or more electromagnetic poles. It will be appreciated that DC motor 34 can be of any suitable voltage, such as 24 volts, 12 volts, 36 volts, etc. The output of the power supply unit 32 is designed to provide the appropriate voltage as required by the specific motor selected, which is a design criterion that is very application specific.

The rotor 58 of motor 34 is coupled to the gearbox 36, which is a conventional 3-stage planetary reduction gear. This includes: a static corona gear 42, a pinion support 44 and three satellite gears 46, in the first stage; a pinion support 48 and three satellite gears 50 in the second stage; and a pinion support 52, three satellite gears 54, and a static corona gear 56 in the third stage. The planetary gearbox 36 provides a reduction ratio of approximately 1:500-1:250.

A tube spacer and noise suppressor 59 is preferably provided around the motor 34, inside the tubular drive system's housing 35. This ensures the quiet operation of the tubular motor 20.

The drive unit 30 is the logistics unit, responsible, among others, for the following desired operation functions:
a. Changing the direction of rotation of the motor, upon manual operation of an external switch;
b. Switching the motor on and off;
c. Automatic stop at the end course, due to the sensitivity of the motor to the current increase at the end course (the increase of the outlet torque), created by mechanical stoppers which prevent further rotation of the shaft;
d. When the electric supply is switched off (i.e., the actuating switch is turned off), the current supply poles are shorted, acting as a brake, and causing the motor to stop.

Alternatively, however, the tubular motor can include alternative stopping means such as brakes and/or revolution counters, as known.

The tubular motor of the preferred embodiment is mechanically simple. It may fulfill its function without many of the conventional elements required by tubular motors of the prior art, such as a metal sleeve, capacitor, brake system, and rotating counter (either mechanical or electronic). The motor senses the force or power which is generated as a result of the end of the action it was directed to perform, and brakes itself.

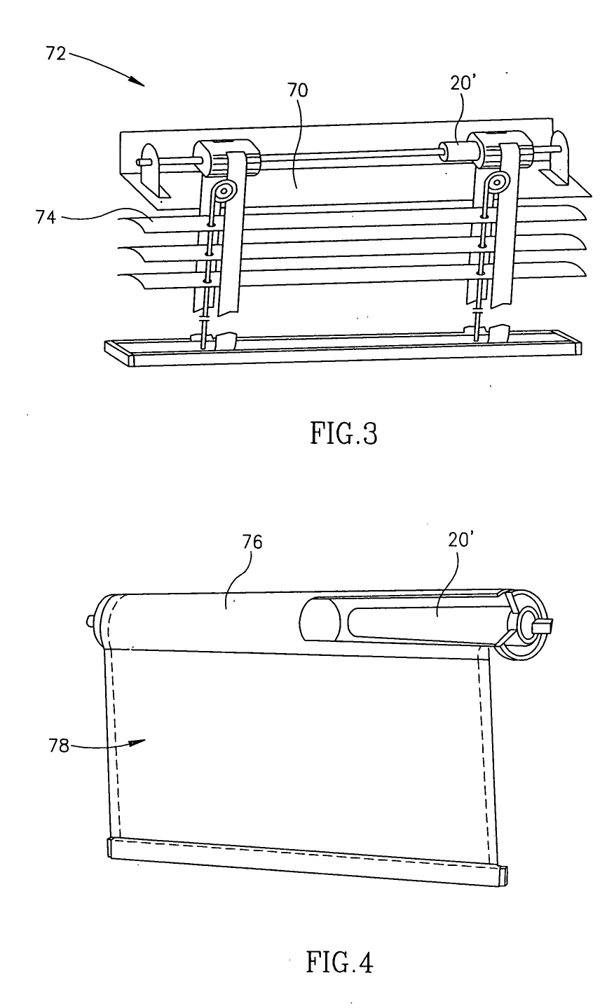

The tubular motor of the preferred embodiment has a moment of rotation of a few tens of Newton meters (Nm), and a speed of a few tens of rotations per minute. Since the preferred embodiment is a narrow tubular motor 20′, being as little as 1 inch wide, its structure permits its insertion into any narrow bar. For example, the tubular motor 20‘may be mounted’ within the headrail 70 of a Venetian blind 72 as shown in FIG. 3; in which case, the wind mechanism may preferably be adapted to additionally allow the tilting of the slats 74. Alternatively, the tubular motor 20′ may be mounted within the spindle 76 of a roller blind 78, as shown in FIG. 4.

In addition to Venetian blinds 72 and roller blinds 78, other applications for such tubular motors include the automated raising and lowering of a wide range of vertical partitions, such as fly screens and mosquito nets, projection screens and sash windows. Mounted vertically, or when adapted by a suitable coupling mechanism, such tubular motors can also be used to open and close curtains, vertical blinds (made from vertical slats) and the like. Indeed, such tubular motors can be used for displacing many devices that hang vertically. They may even be used for automating the opening and closing of barriers for parking lots. The exact size and cost of the tubular motor will depend on the torque required, which is a function of the specific application. However, even heavy loads such as sash windows, or chalk boards or marker boards in lecture theatres, can be raised and lowered by relatively small tubular motors, if they are properly counter-weighted.

Using a compact DC type tubular motor of the present invention, instead of an AC asynchronous type tubular motor for raising and lowering or otherwise displacing vertical screens provides many advantages:
1. The motor weighs only about ¼ to 1/3 as much as an AC asynchronous-type motor of similar power, and is significantly cheaper.
2. The drive circuit cuts the power to the DC motor when the strain on it changes significantly, thus the tubular motor senses the increase of the torque indicating the end course and stops itself, no extra mechanical braking system or revolving counter being required.
3. Having a relatively high electromechanical efficiency, it does not warm up rapidly, so it can operate continuously, and does not need to have its power cut after a few minutes to prevent it overheating.
7. Due to its high efficiency relative to an AC asynchronous motor, only a fraction of the power is needed. Apart from energy saving, this enables the tubular motor to be temporarily powered by disposable or rechargeable batteries, to provide a back-up power source, in case of a failure of the mains power, for example.
8. Unlike the tubular motor using an AC asynchronous type motor of the prior art, operation of the DC type tubular motor of the present invention does not generate large quantities of heat, requiring quick dissipation. Thus, no metal or vented housing is required. Optionally and preferably, the tubular housing may be made of an insulating material such as plastic. Being doubly isolated, there is no need for a grounding wire, and simple, unobtrusive, flat two-wire cord may be used for connecting the tubular motor to the mains electricity.

Compared with the DC tubular motors of the prior art, the tubular motor of the present invention has the advantage that it may be powered by plugging into the mains, without the requirement an unsightly, bulky power pack somewhere along the power cord, external to the tubular motor housing.

### EXAMPLE

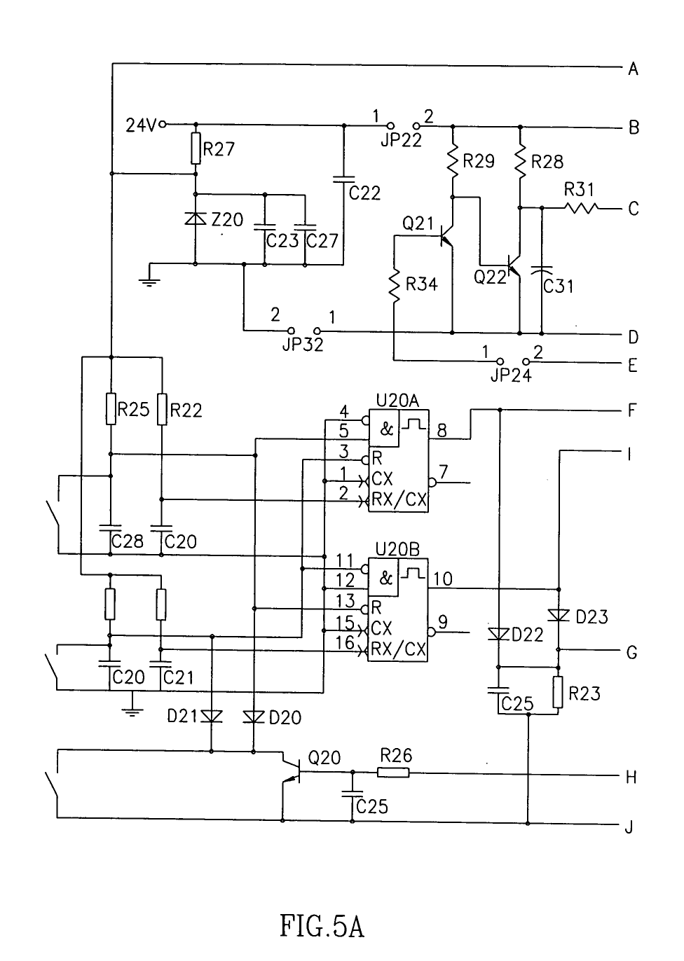

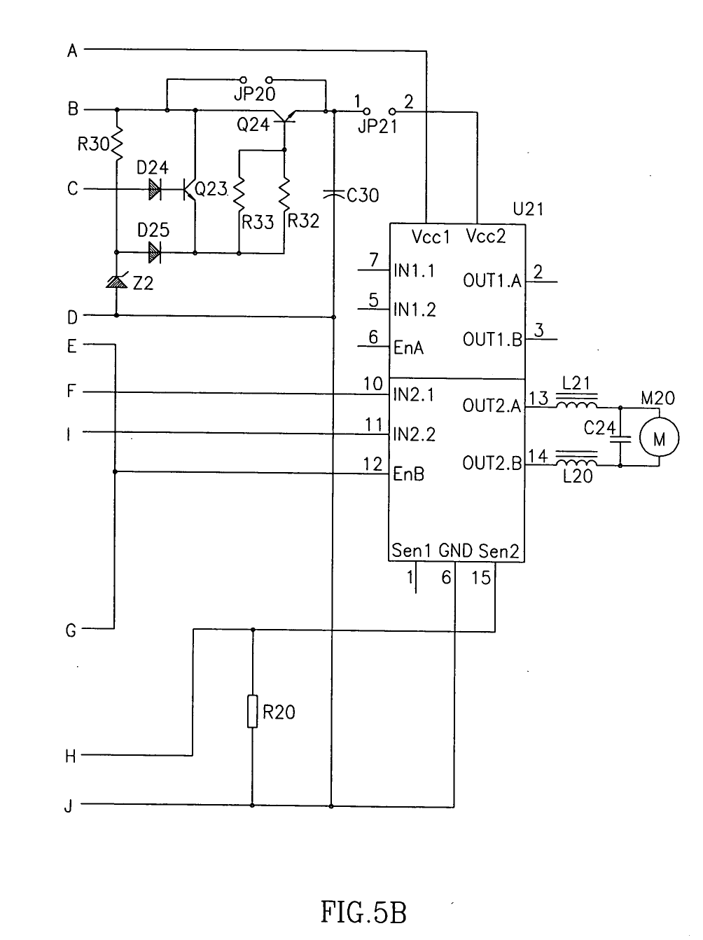

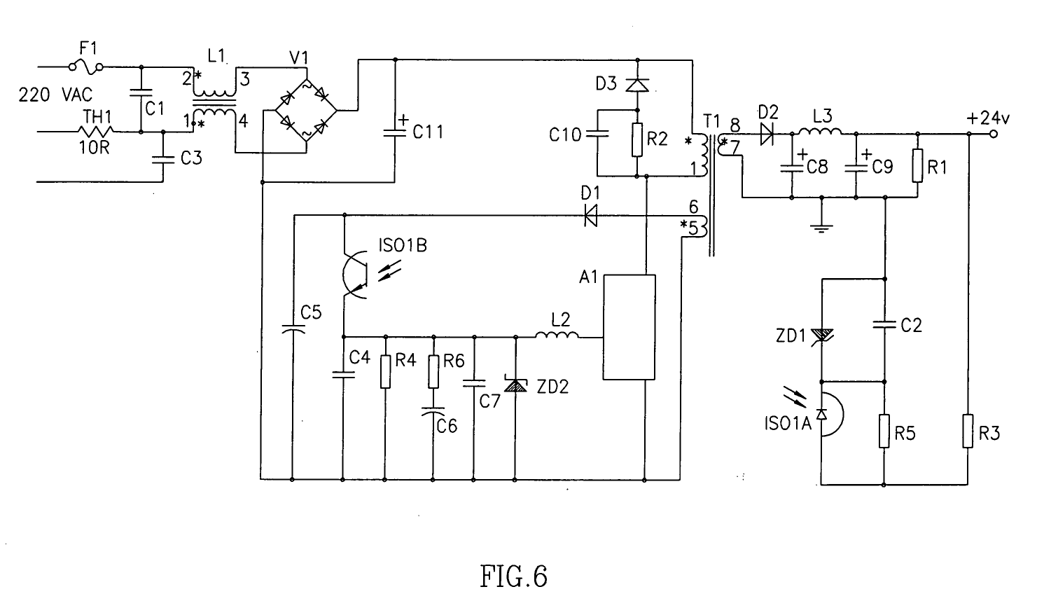

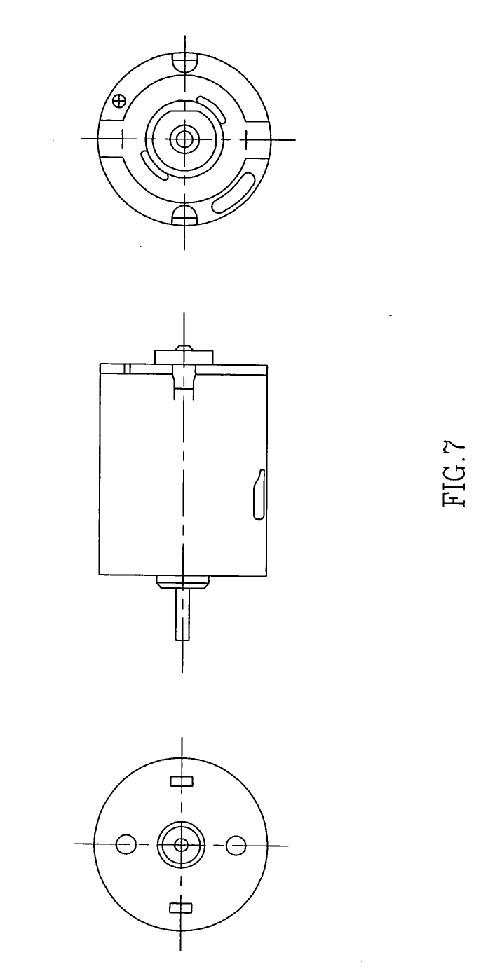

Reference is now made to FIG. 5, which is a circuit diagram of one embodiment of a drive unit 10′, to FIG. 6, which is a circuit diagram of one embodiment of a unitary power supply 12′, and to FIG. 7, which is an engineer's plan of the DC motor 14′ of a working prototype tubular motor 2′. These Figures, when studied with Tables 1 and 2, provide full parts lists of an exemplary example of how the tubular motor of the present invention may be realised.

TABLE 1
Parts List for Exemplary Drive Unit 10′

| | | | | | Tol- | PCB | | Manu- | |
|---|---|---|---|---|---|---|---|---|---|
| Item | Quantity | Reference | Part Type | Part Type | erance | Footprint | Case Type | facturer | Supplier |
| 1 | 2 | C20,C21 | Ceramic Capacitor | *uF | | SMD | 0805 | | |
| 2 | 2 | C22,C23 | Ceramic Capacitor | 0.1 uF 50 V | | SMD | 0805 | SAMSUNG | CIDEV |
| 3 | 1 | C24 | Ceramic Capacitor | 0.47 uF 50 V | | TH | | MURATA | STG |
| 4 | 3 | C25,C26,C27, | Capacitor Electrolytic | 10 uF 50 V | | TH | 5X11 | YAGEO | CIDEV |
| | | C30 | | | | | | | |
| 5 | 1 | C31 | Capacitor Electrolytic | 220 uF 35 V | | TH | 8X11 | YAAGEO | CIDEV |
| 6 | 2 | C28,C29 | Ceramic Capacitor | 1 uF 16 V | | SMD | 0805 | SAMSUNG | CIDEV |
| 7 | 8 | D20..D25 | Diode Switching | 100 V 200 mA | | SMD | SOD-123 | ON SEMI | ZIONTRONICS |
| 8 | 2 | L20,L21 | Choke | 15 uH 2 A | | TH | | FASTRON | ZIONTRONICS |
| 9 | 1 | M20 | Motor (external) | | | | | | |
| 10 | 4 | Q20..Q23 | Transistor NPN | 0.1 A 80 V | | SMD | SOT-23 | ON SEMI | ZIONTRONICS |
| 11 | 1 | Q24 | Transistor NPN | | | SMD | DPAK & TO-92 | ON SEMI | ZIONTRONICS |
| 12 | 1 | R20 | Resistor SMD | *R 0.25 W | ±5% | SMD | 1206 | SAMSUNG | CIDEV |
| 13 | 2 | R21,R22 | Resistor SMD | *R 0.125 W | ±5% | SMD | 0805 | SAMSUNG | CIDEV |
| 14 | 1 | R23 | Resistor SMD | 100 K 0.125 W | ±5% | SMD | 0805 | SAMSUNG | CIDEV |
| 15 | 2 | R24,R25,R29, | Resistor SMD | 10 K 0.125 W | ±5% | SMD | 0805 | SAMSUNG | CIDEV |
| | | R33 | | | | | | | |
| 16 | 1 | R26 | Resistor SMD | 15 K 0.125 W | ±5% | SMD | 0805 | SAMSUNG | CIDEV |
| 17 | 1 | R27,R30,R31 | Resistor SMD | 1 K 0.125 W | ±5% | SMD | 0805 | SAMSUNG | CIDEV |
| 18 | 1 | R28 | Resistor SMD | 5.1 K 0.125 W | ±5% | SMD | 0805 | SAMSUNG | CIDEV |
| 19 | 2 | R32,R33 | Resistor SMD | 100 R 0.125 W | ±5% | SMD | 0805 | SAMSUNG | CIDEV |
| 20 | 1 | S20 | Switch Control | | | | | | |
| | | | “LEFT” (external) | | | | | | |
| 21 | 1 | S21 | Switch Control | | | | | | |
| | | | “RIGHT” (external) | | | | | | |
| 22 | 1 | S22 | Switch Control | | | | | | |
| | | | “STOP” (external) | | | | | | |
| 23 | 1 | U20 | Dual Multivibrator | | | SMD | SOIC-16 | ON SEMI | ZIONTRONICS |
| 24 | 1 | U21 | Dual Full-Bridge | | | TH | Multiwatt Vert. | ST | A.Y. Electronics |
| | | | Driver | | | | | | |
| 25 | | JP20 | Jamper | | | TH | | | |
| 26 | 1 | Z20 | Zener | 6.2 V 0.5 W | ±5% | SMD | SOD-123 | ON SEMI | ZIONTRONICS |
| 27 | 1 | Z21 | Zener | 15 V 0.5 W | ±5% | SMD | SOD-123 | ON SEMI | ZIONTRONICS |

TABLE 2
Parts List for Exemplary Unitary Power Supply 12′

| | | | | | | PCB | PCB | | | |
|---|---|---|---|---|---|---|---|---|---|---|
| Item | Quantity | Reference | Rev | Part Type | Part Value | erance | Footprint | Case Type | Manufaturer | Supplier |
| 1 | 1 | A1 | | Topswitch | 1.7 A 700 V | | TH | TO-220 | PANASONIC | CAPITAL |
| 3 | 1 | C1 | | Noise Suppression | Not used | | TH | | OKAYA | WAVE |
| | | | | Capacitor | | | | | | |
| 4 | 1 | C2 | A | Ceramic Capacitor | 0.47 uF 50 V | | SMD | 1206 | SAMSUNG | CIDEV |
| 5 | 1 | C3 | | Ceramic Capacitor | Not used | | TH | | MURATA | CAPITAL |
| 6 | 1 | C5 | | Capacitor Electrolytic | 10 uF 50 V | | TH | 5X11 | YAGEO | CIDEV |
| 7 | 1 | C8 | | Capacitor Electrolytic | 47 uF 63 V | | TH | 6.3x11 | SAMSUNG | CIDEV |
| 8 | 1 | C7 | | Ceramic Capacitor | 0.1 uF 50 V | | SMD | 0805 | SAMSUNG | CIDEV |
| 9 | 2 | C8,C9 | | Capacitor Electrolytic | 220 uF 35 V | | TH | 8X11 | YAGEO | CIDEV |
| 10 | 1 | C10 | | Ceramic Capacitor | 2200 pF 1 kV | | TH | | MURATA | STG |
| 11 | 1 | C11 | | Capacitor Electrolytic | 2.2 uF 450 V | | TH | 10x12.5 | SAMWHA | HARZION |
| 12 | 1 | D1 | | Diode Switching | 100 V 200 mA | | SMD | SOD-123 | ON SEMI | ZIONTRONICS |
| 13 | 1 | D2 | | Ultra Fast Rectifier | 100 V 3 ZA | | TH | DO-27 | DC | ZIONTRONICS |
| 14 | 1 | D3 | | Diode | 1000 V 1 A | | TH | | TOSHIBA | DATA-JCE |
| 15 | 1 | F1 | | Fuse | 250 V 0.5 A | | TH | 5X20 | | |
| 16 | 1 | ISO1 | | Optocoupler | | | TH | DIP-4 | NEC | DATA-JCE |
| 17 | 1 | L1 | | Line Filter | Not used | | TH | | MATSUTA | VITEL |
| 18 | 1 | L2 | | Ferile Bead | | | — | | | |
| 19 | 1 | L3 | | Choke | 15 uH 2 A | | TH | | FASTRON | ZIONTRONICS |
| 20 | 1 | R1 | | Resistor SMD | *R 0.125 W | | SMD | 0805 | SAMSUNGF | CIDEV |
| 21 | 1 | R2 | | Resistor Film | 20 K 2 W | ±5% | TH | | YAGEO | CIDEV |
| 22 | 1 | R3 | A | Resistor SMD | 2 K 0.125 W | ±5% | SMD | 0805 | SAMSUNG | CIDEV |
| 23 | | R4 | A | Resistor SMD | Not used | | SMD | 0805 | | |
| 24 | 1 | R5 | | Resistor SMD | 2 K 0.125 W | ±5% | SMD | 0805 | SAMSUNG | CIDEV |
| 25 | 1 | R6 | | Resistor SMD | 5 R1 0.125 W | ±5% | SMD | 0805 | SAMSUNG | CIDEV |
| 26 | 1 | T1 | | Transformer | | | TH | | | |
| 27 | 1 | TH1 | | Termistor | 5 R | | TH | | | |
| 28 | 1 | V1 | | Bridge Diode | 400 V 2 A | | TH | | DC | ZIONTRONICS |
| 29 | 1 | ZD1 | | Zener Diode | 24 V 0.5 A | | TH | | ON SEMI | ZIONTRONICS |
| 30 | 1 | ZD2 | | Zener Diode | 18 V 1 W | | TH | | ON SEMI | ZIONTRONICS |

TABLE 3
Characteristics Provided by the Working Prototype Tubular Motor 2′

| | |
|---|---|
| LENGTH OF SHAFT (A): 43.0 MM (±0.1) | FRONT EXTENSION (B): 10.0 MM (±0.5) |

| | | NO LOAD | | AT MAXIMUM EFFICIENCY | | | | | AT MAXIMUM POWER | | | | | |
|---|---|---|---|---|---|---|---|---|---|---|---|---|---|---|
| | | | CURR- | | CURR- | | OUT- | | | CURR- | | STALL | NOISE | |
| MODEL | | SPEED | ENT | SPEED | ENT | TORQUE | PUT | EFF | SPEED | ENT | TORQUE | TORQUE | dBA | |
| FRC-280S-07730V | | R.P.M. | A | R.P.M. | A | gf · cm | W | % | R.P.M. | A | gf · cm | gf · cm | (Max) | mm |
| NOM- | 24 V | 4860 | 0.02 | 3730 | 0.07 | 25.0 | 0.96 | 56.9 | 2430 | 0.13 | 53.0 | 107 | 72 | 300 |
| INAL | CONSTANT | | | | | | | | | | | | | |
| VOLT- | 12.0˜30.0 V | ±12% | 0.04 | ±12% | 0.09 | 22.1 Min | 0.86 | 51.2 | ±12% | 0.16 | 47.7 | 96.3 Min | | |
| AGE | | | Max | | Max | | Min | Min | | Max | Min | | | |
| RAN- | | | | | | | | | | | | | | |
| GE | | | | | | | | | | | | | | |

Weight = 47 g

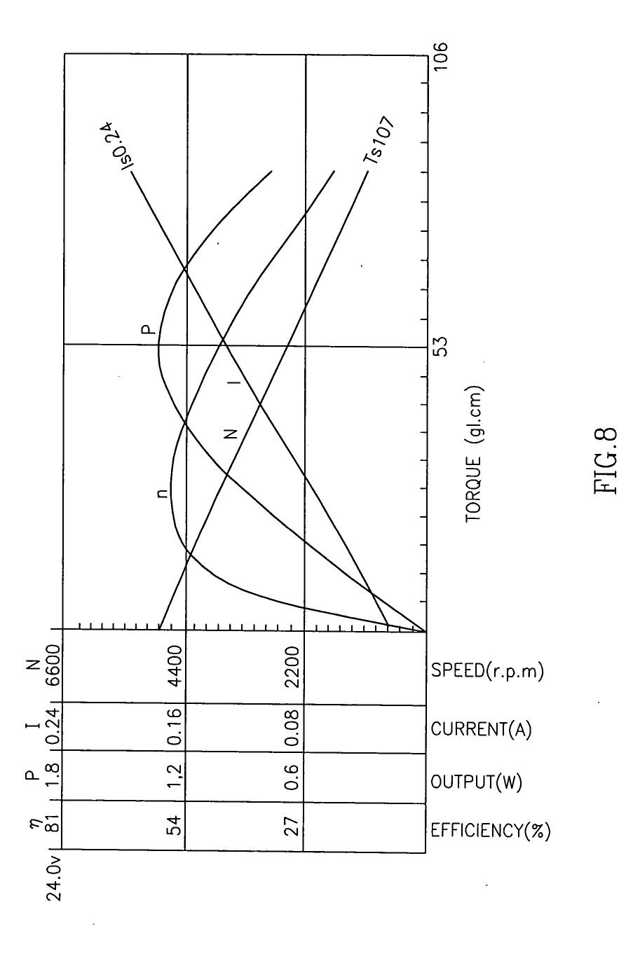

Table 3 and FIG. 8 summarise the characteristics provided by the working prototype tubular motor 2′. It will be noted that the mechanical efficiency of exemplary tubular motor 2′ is very high, compared to conventional AC-type tubular motors, about 50-60%, since the motor is not asynchronous.

It will be appreciated that the invention is not limited to what has been described hereinabove merely by way of example. Rather, the invention is limited solely by the following claims.

1. A tubular motor comprising:
a driving system and a winch mechanism enclosed within a common tubular housing, wherein
said driving system includes a DC motor and a unitary power supply, said unitary power supply being electrically connectable to an AC electricity source external to said housing and to said DC motor within said housing, and being adapted to convert AC electricity supplied by said AC electricity source into low voltage direct current electricity suitable for said DC motor, by transformation and rectification; and
said winch mechanism is coupled to and driven by said DC motor.

2. A tubular motor as claimed in claim 1, wherein said tubular motor is coupled to a vertical partition suspended from a horizontal bar, and said tubular motor enables an automated displacement of said vertical partition.

3. A tubular motor as claimed in claim 2, wherein said vertical partition is selected from the group consisting of a venetian blind, a curtain, a roller blind, a fly screen, a mosquito net, a sash window, a projection screen, a chalk board and a marker board.

4. A tubular motor as claimed in claim 2 or 3, wherein said horizontal bar constitutes said tubular housing.

5. A tubular motor as claimed in any of the preceding claims, wherein said driving system further comprises a drive unit that includes a logic circuit for controlling operation and braking of said DC motor.

6. The tubular motor according to claim 5, wherein said logic circuit is enabled to sense a current increase when said motor has reached an end course.

7. A tubular motor as claimed in any of the preceding claims, wherein said DC motor is a collector type motor including a solid magnet stator, and a wire coiled collector rotor, having three or more electromagnetic poles.

8. The tubular motor as claimed in any of the preceding claims, wherein said winch mechanism includes a planetary reduction gear.

9. The tubular motor according to claim 7, wherein said planetary reduction gear is a three-stage gear.

10. The tubular motor according to any of the preceding claims, wherein said tubular housing has at least one of the following characteristics
(a) said tubular housing is electrically insulating.
(b) said tubular housing is less than 1½ inches wide.

11. The tubular motor according to any of claims 1 to 10, further comprising a back-up battery as an alternative power source for powering said DC motor.
